(19) United States
(12) Patent Application Publication
(10) Pub. No.: US 2013/0268445 A1
(43) Pub. Date: Oct. 10, 2013

(54) REAL-TIME RECALL INVENTORY MATCHING SYSTEM

(71) Applicants: Peter Casady, Schaumburg, IL (US); Jim Sipe, Phoenix, AZ (US)

(72) Inventors: Peter Casady, Schaumburg, IL (US); Jim Sipe, Phoenix, AZ (US)

(21) Appl. No.: 13/763,977

(22) Filed: Feb. 11, 2013

Related U.S. Application Data
(60) Provisional application No. 61/603,045, filed on Feb. 24, 2012.

(51) Int. Cl. G06Q 30/00

(52) U.S. Cl. CPC G06Q 30/014
USPC 705/303

(57) ABSTRACT

A real-time process to automatically match medical device recall information to a healthcare provider's inventory and history to alert healthcare personnel of a recall associated with a medical device.

### CROSS REFERENCE TO RELATED APPLICATION

This application claims the benefit of U.S. Provisional Patent Application No. 61/603,045, filed on 24 Feb. 2012. This co-pending provisional patent application is hereby incorporated by referenced herein in its entirety and is made a part hereof, including but not limited to those portions which specifically appear hereinafter.

### BACKGROUND OF THE INVENTION

1. Field of the Invention

This invention is directed to a system and method for storing, managing and alerting subscribers of a product recall, for example for product recalls for medical devices.

2. Discussion of Related Art

Currently, the most common process for managing a medical device recall, whether using a hospital-based medical device inventory management system or a manual system, involves healthcare personnel checking written or electronic health records (EHR) one at a time to determine if a recalled device may have been used in patient care or is currently in facility inventory. This process can take a long time to complete and is subject to possible error.

Another known process for investigating a medical device recall utilizes a subscriber-based inventory management system. This process includes copying and pasting recalled medical device product codes and/or catalog, lot or serial numbers into a search window of the subscriber-based inventory management system to determine if a recalled device may have been used in patient care or is in the facility's inventory. This process is faster than the manual process described above, but still requires multiple cutting and pasting of every item in a recall notification to determine what, if any, history there may be in the facility.

Both methods for managing medical device recalls described above also fail to automatically notify a healthcare provider if a newly accepted medical device was previously recalled.

Accordingly, there is a need for an improved system for managing recalls of medical devices.

### SUMMARY OF THE INVENTION

A general object of the invention is to provide a real-time process to automatically match medical device recall information to a healthcare provider's inventory and records to alert healthcare personnel of the recall.

The real-time recall inventory matching system of this invention provides visibility of recalled inventory that is currently within a facility, reducing the likelihood of future use of those devices in patient care. The system also identifies patients that may have been exposed to the recalled device in the past allowing a healthcare provider to take corrective action. The system of this invention also prevents the healthcare provider from accepting a previously recalled device, with or without prior history in the healthcare facility, into a healthcare facility, such as a hospital. In a preferred embodiment of this invention, the system alerts the healthcare provider with a visual alert within a subscriber-based system as well as with an e-mail to an authorized user of the healthcare provider with the details of the recall, including patients that may have been affected and a report or summary of current inventory status of devices still in the facility.

Suppliers and manufacturers of medical devices currently have no visibility at the healthcare facility level when one of their recalled products remains in inventory or has been used in patient care. The suppliers and manufacturers currently rely on hospitals and other healthcare providers to do this research for them. The system of this invention allows suppliers and manufacturers, as well as subscribers and other groups, to generate report of recalls, usage, inventory and patient outcomes, thereby providing greater visibility into product performance.

### BRIEF DESCRIPTION OF THE DRAWINGS

These and other objects and features of this invention will be better understood from the following detailed description taken in conjunction with the drawings, wherein:

FIG. 1 is a representation of a system for automatically managing recall information according to one embodiment of this invention.

FIG. 2 is a flow chart for a method for automatically managing recall information according to one embodiment of this invention.

FIG. 3 is a flow chart for a method for adding a subscriber system to the system of FIG. 1.

FIG. 4 is a flow chart for adding and/or editing a supplier identifier to the system of FIG. 1.

FIG. 5 is a flow chart for adding and/or editing a device identifier to the system of FIG. 1.

FIG. 6 is a flow chart for adding and/or editing a production identifier to the system of FIG. 1.

FIG. 7 is a flow chart for adding a recall to the system of FIG. 1.

FIG. 8 is a flow chart for alerting a user of the subscriber system according to one embodiment of this invention.

FIG. 9 is a flow chart for storing and generating reports from the system of FIG. 1.

FIG. 10 is a flow chart for a process for a global subscriber to generate an aggregate data report from the system of FIG. 1.

FIG. 11 is a flow chart for a process for a supplier subscriber to generate an aggregate data report from the system of FIG. 1.

### DESCRIPTION OF PREFERRED EMBODIMENTS

The present invention provides a system and method for storing and managing product recall information for example, but not limited to, recalls of medical devices. The following description will focus on applying the system and method of this invention to the recall and management of medical devices. However, it should be understood that the system and method of this invention is not limited to the recall of medical devices and may be used to handle recalls of any type of product including, but not limited to, aeronautical parts, automotive parts, toys and food.

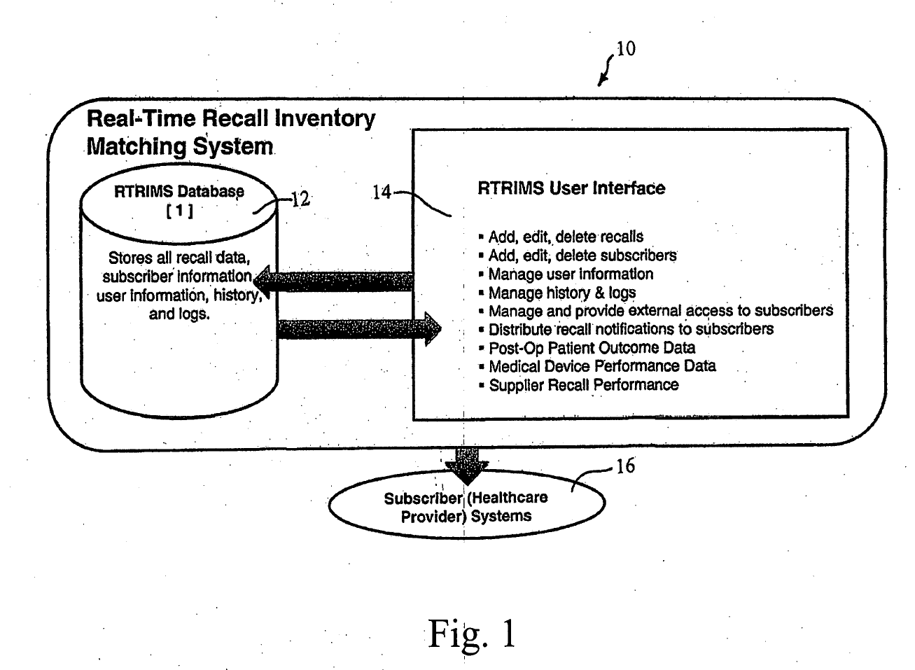

FIG. 1 shows a representation of a Real-Time Recall Inventory Matching System (RTRIM system) 10 according to an embodiment of this invention. The RTRIM system 10 of this invention compares a recall for a medical device to a healthcare provider's inventory and usage history. If the recalled medical device has ever been used in patient care and/or stored in inventory of a medical facility or group of facilities, the RTRIM system 10 alerts the healthcare provider automatically and provides details of the recall.

The RTRIM system 10 preferably includes a RTRIMS database 12 and a RTRIMS user interface 14. The RTRIMS database 12 stores information including recall data, subscriber information, user information, history and logs. For example, Table 1 provides a list of recall data stored in the RTRIMS database 10 in one embodiment of this invention.

TABLE 1

Recall Class
Device Class
Date Posted
Recall Number
Product
Description
Code Information
Product Code(s)/Part Number(s)/Reference
Number(s)/Catalog Number(s)
Lot Number(s)/Serial Number(s)/ID
Number(s)
Recalling Firm/Supplier/Manufacturer
Supplier Name(s)
Supplier Address
For Additional Information Contact
Reason for Recall
Action
Quantity in Commerce
Distribution
Source of Recall Information
Urgency

However, it should be understood, that the information stored in the RTRIMS database 12 is not limited to the information included in Table 1 and may include additional information including, but not limited to, product identifiers, care instructions, expiration dates, and other information related to the product and/or the recall. The RTRIMS user interface 14 allows a user to update and revise the RTRIMS database 12 including: add, edit and delete recalls; add, edit and delete subscribers; manage user information; manage history and logs; manage and provide external access to subscribers; distribute recall notifications to subscribers; post-operation patient outcome data; report medical device performance data; and report supplier recall performance.

In a preferred embodiment, a subscriber, for example a hospital, acute care facility or other healthcare providers, connects a subscriber system 16, for example a hospital database with product inventory and a history of product usage, to the RTRIM system 10. When a new medical device is entered into inventory and/or usage of the subscriber system 16, the RTRIM system 10 compares the new medical device to the recall information stored in the RTRIMS database 12 to determine if the new medical device has ever been recalled and, if so, issues an alert to the subscriber system 16. Additionally, whenever a new recall is entered into the RTRIMS database 12, the RTRIM system 10 searches inventory and records of the subscriber system 16 to determine if the subscriber system 16 has or has used the newly recalled device, and if so, issues an alert to the subscriber system 16. Preferably, the automated alerts are real-time automated recall alert notifications based on real-time medical device data.

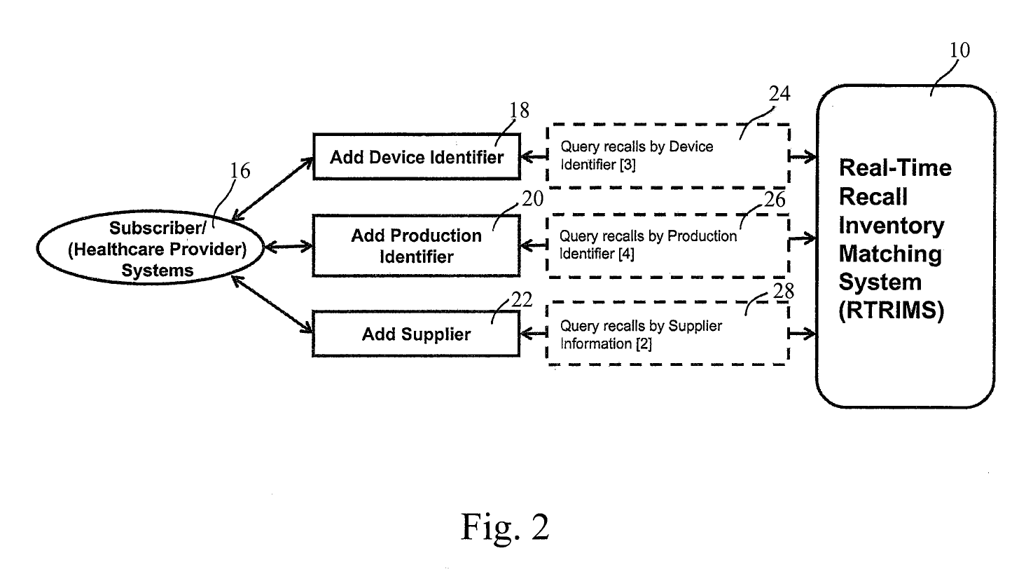

FIG. 2 shows a flowchart overview of a preferred embodiment of the RTRIM system 10 of this invention. The flowchart provides a process to determine if a medical device newly entered into the subscriber system 16 or edited in the subscriber system 16 has been subject to a recall. In this embodiment, the new medical device may be entered into the subscriber system 16 using one or more identifiers, for example, but not limited to, a device identifier 18, a production identifier 20 and a supplier identifier 22. Each of the identifiers 18, 20, 22 at least partially corresponds to the recall data stored in the RTRIMS database 12 so that the RTRIM system 10 can determine if there is match. When one or more identifiers 18, 20, 22 is added to or edited in the subscriber system 16, a query 24, 26, 28 will be sent to the RTRIM system 10 to see if there are any applicable recalls. If so, a recall alert will be sent to the subscriber system 16. In an alternative embodiment, any recall data entered into the RTRIM system 10 is automatically sent and stored in each subscriber system 16. With this alternative embodiment, any time one or more identifiers 18, 20, 22 is added or edited to the subscriber system 16, the subscriber system 16 can automatically determine if the product associated with the identifier 18, 20, 22 without querying the RTRIM system 10.

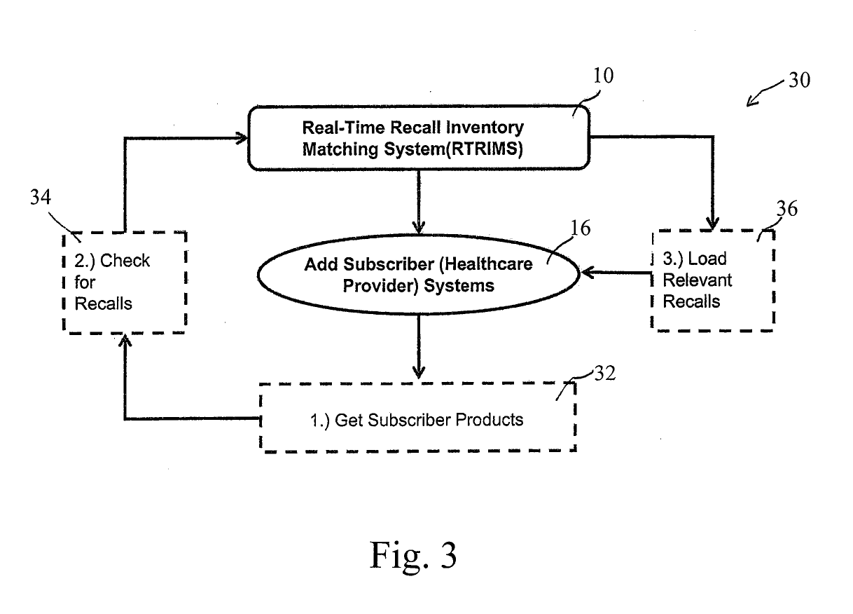

FIG. 3 shows a flow chart for a process 30 for adding the subscriber system 16 to the RTRIM system 10 according to an embodiment of this invention. After the new subscriber system 16 is associated with the RTRIM system 10, the RTRIM system 10 checks the new subscriber's 16 current inventory of medical devices and reports or histories of medical devices used by the new subscriber 16 to get a list of subscriber products 32. The RTRIM system 10 then compares the list of subscriber products to recall information stored in the RTRIMS database 12 to check for recalls 34. If a relevant recall is found, the recall data is sent 36 to the subscriber system 16 and, if appropriate, an alert is displayed on or otherwise transmitted to the subscriber system 16. In an alternative embodiment, all recall data is automatically loaded and saved in the subscriber system 16 to be used to display relevant recall information in a timely matter for all medical devices taken into inventory or used in medical procedures without querying the RTRIMS database 12. The new subscriber 16 will also be set up in the RTRIM system 10 to receive real-time alerts on an on-going basis for the duration of a subscription.

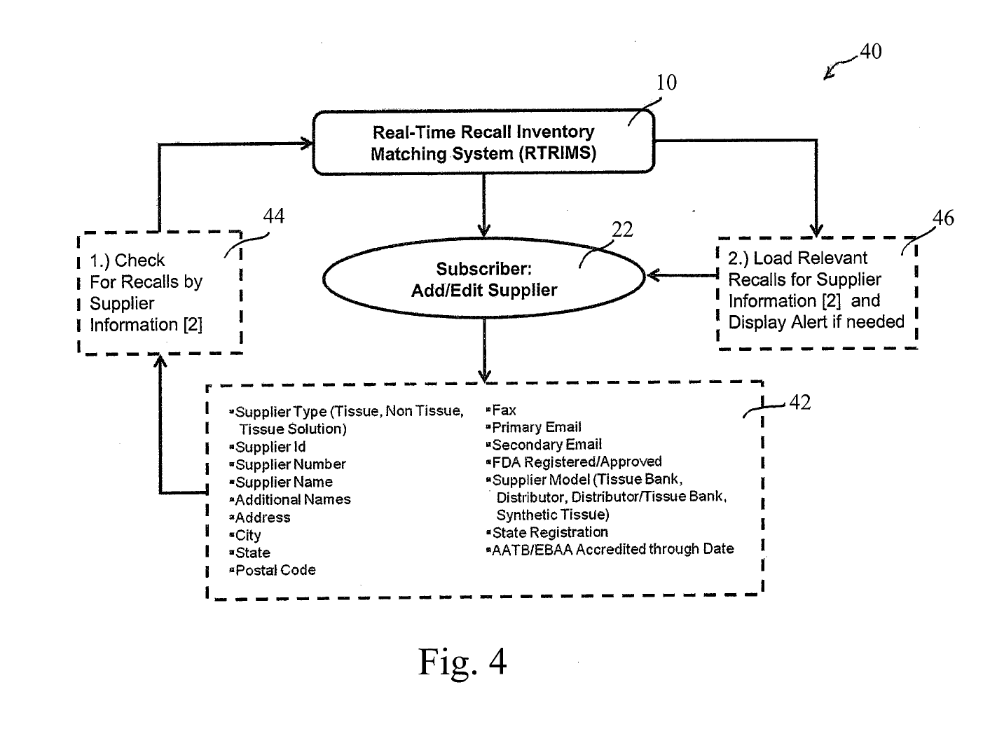

FIG. 4 is a flow chart for a process 40 for adding a new product or editing an existing product to the subscriber system 16 with the supplier identifier 22. In an embodiment of this invention, data of the supplier identifier 22 may include, but not limited to, information shown on Table 2.

TABLE 2

Supplier ID/Supplier Number
Supplier Name(s)
Supplier Address
Supplier Type (tissue, non-tissue, tissue solution)
Facsimile Number
E-mail
FDA Registered/Approved
Supplier Model (Tissue Bank, Distributor,
Distributor/Tissue Bank, Synthetic Tissue)
State Registration
AATB/EBAA Accredited Through Date

After the supplier identifier 22 is added or edited 42 to the subscriber system 16, a query 44 is sent to the RTRIM system 10 to check for recalls associated supplier identifier 22. If the RTRIM system 10 determines that there are relevant recalls, the RTRIM system 10 loads the relevant recalls 46 to the subscriber system 16 and, if appropriate, an alert is displayed on the subscriber system 46. In another embodiment, the real-time alert is electronically transmitted to an appropriate representative of the subscriber system 16.

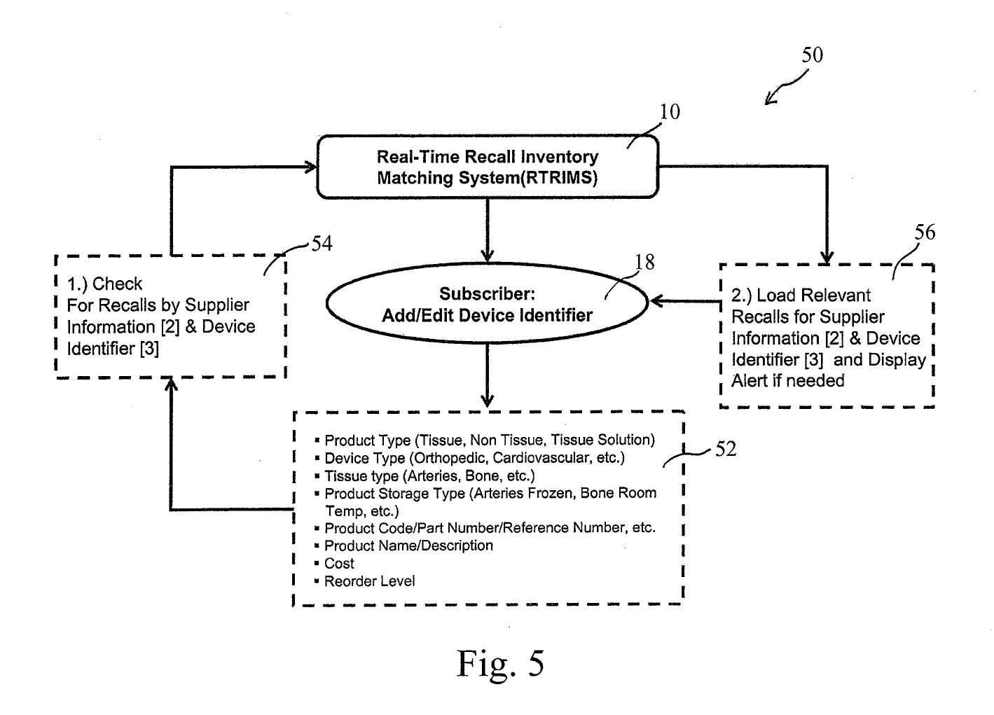

FIG. 5 is a flowchart 50 for adding and/or editing the device identifier 18 of the subscriber system 16. In an embodiment of this invention, the device identifier 18 includes information shown in Table 3.

TABLE 3

Device Identifier (static)
Product
Description
Code Information
Product Code(s)/Part Number(s)/Reference
Number(s)/Catalog Number(s)
Product Type (Tissue, Non Tissue, Tissue Solution)
Device Type (Orthopedic, Cardiovascular, etc.)
Tissue Type (Arteries, Bone, etc.)
Product Storage Type (Arteries Frozen, Bone Room
Temp., etc.)
Cost
Reorder Level

In a preferred embodiment of this invention, when a device identified by the device identifier 18 is added to or edited 52 in the subscriber system 16, a query 54 is sent to the RTRIM system 10 to check for recalls associated with the supplier identifier 22, Table 2, and the device identifier 18, Table 3. If the RTRIM system 10 determines that the newly entered or edited device has been subject to a recall, the RTRIM system 10 loads relevant recalls to the subscriber system and, if needed, sends an alert to the subscriber system 16 by displaying the alert on the subscriber system 16. Alternatively, the RTRIM system 10 may send an alert by e-mail and/or another electronic notification system including but not limited to a text message and an automated phone call.

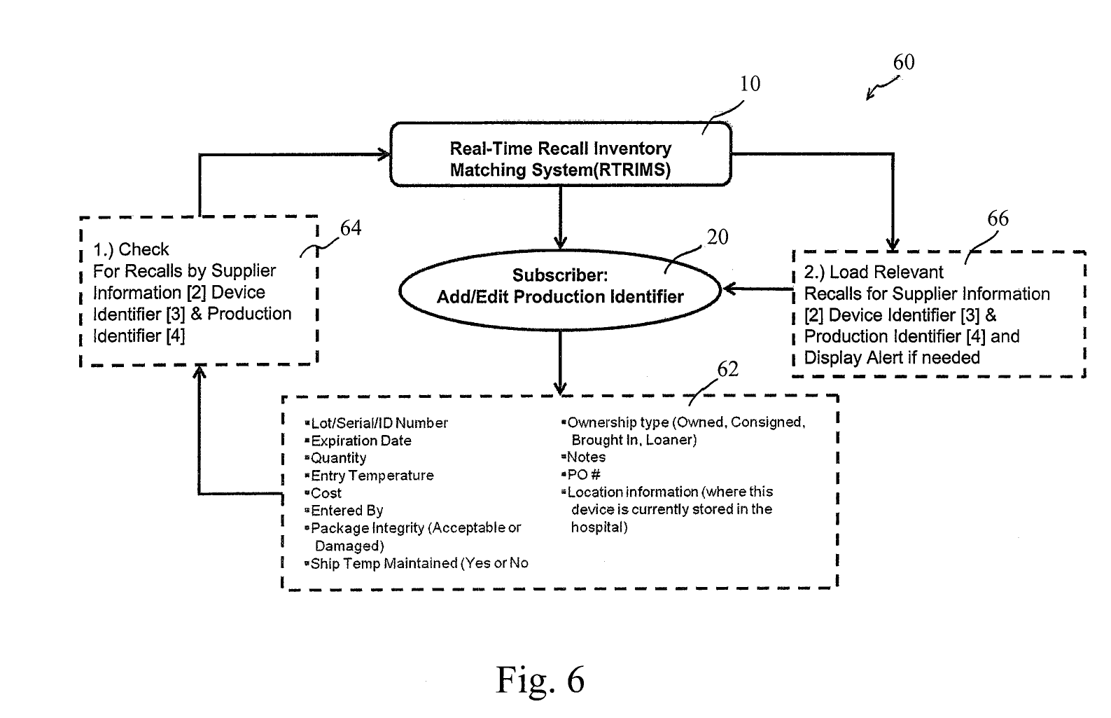

FIG. 6 is a flowchart 60 for adding or editing a device to the subscriber system with the production identifier 20. In an embodiment of this invention, the production identifier 20 may include information shown in Table 4.

TABLE 4

Production Identifier (dynamic)
Code Information
Lot Number(s)/Serial Number(s)/ID
Number(s)
Expiration Date
Quantity
Entry Temperature
Cost
Entered By
Package Integrity (Acceptable or Damaged)
Ship Temp Maintained (Yes or No)
Ownership Type (Owned, Consigned, Brought In,
Loaner)
Notes
PO #
Location Information (where this device is currently
stored in the hospital)

In a preferred embodiment of this invention, when a device with the production identifier 20 is added to or edited 62 in the subscriber system 16, a query 64 is sent to the RTRIM system 10 for recalls associated with the device identified in at least one of the supplier identifier 22, Table 2, the device identifier 18, in Table 3, and the production identifier 20, Table 4. If a relevant recall is found, the RTRIM system 10 sends a real-time alert to the subscriber system 16. Alternatively, the RTRIM system 10 may send an alert by e-mail and/or another electronic notification system including but not limited to a text message and an automated phone call.

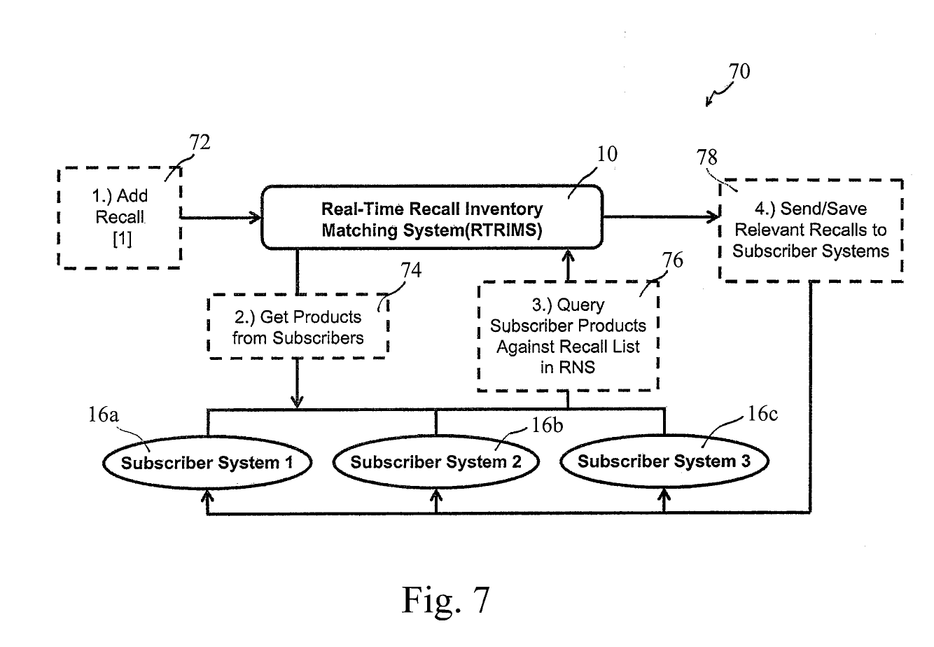

FIG. 7 is a flow chart for a process 70 for adding a new product recall to the RTRIM system 10 according to a preferred embodiment of this invention. The process 70 starts by entering a product recall 72 to the RTRIM system 10. Preferably, the product recall 72 includes at least one of a recall device identifier, a recall production identifier and a recall supplier identifier. In an embodiment of this invention, the product recall 72 may be entered into the RTRIM system 10 with the RTRIMS user interface 14. Alternatively, the new product recall may be transferred to the RTRIM system 10 from a manufacturer or supplier of the recalled product. After the new product recall is added to the RTRIM system 10, the RTRIM system 10 gets a list of products 74 currently in inventory and products used in procedures from each of the plurality of subscriber systems 16a, 16b, 16c. The RTRIM system 10 the compares 76 the list of products from each of the subscriber systems 16a, 16b, 16c to determine if any of the subscriber systems have current inventory or product history related to the new product recall. If a match is found, an alert is sent to the appropriate subscriber system 16a, 16b, 16c. In a preferred embodiment, the RTRIM system 10 also sends the alert to the subscriber system 16 by e-mail and/or another electronic notification system including but not limited to a text message and an automated phone call.

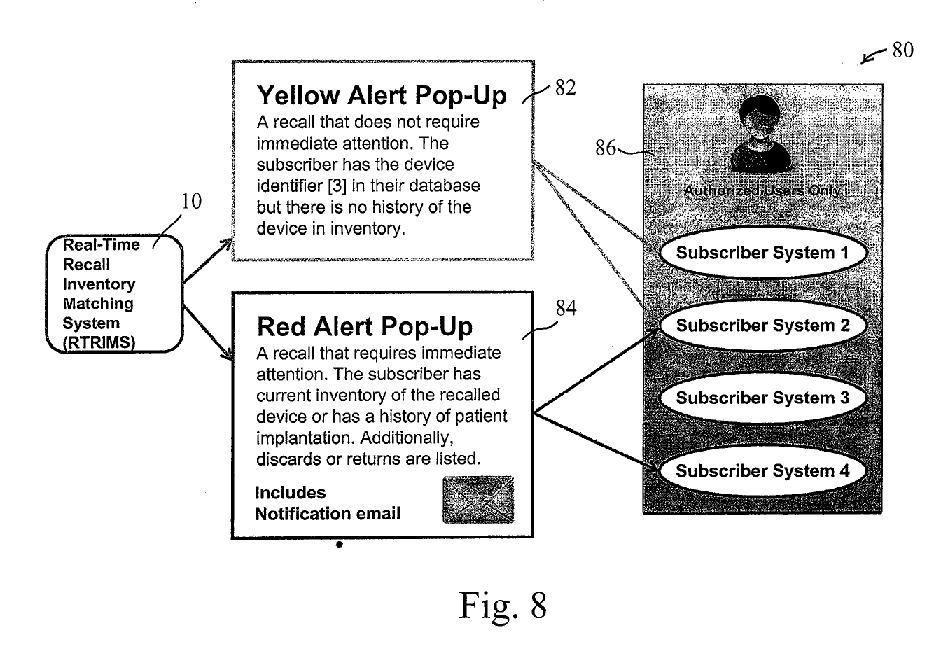

In a preferred embodiment of this invention, the alert system comprises a two-tiered alert notification system 80 for providing real-time recall notifications to the subscriber systems 16. FIG. 8 shows a preferred embodiment of the two-tiered alert notification system 80 of this invention. When the RTRIM system 10 determines a recall notification is applicable to a medical device in the subscriber system's 16 inventory or records, the RTRIM 10 system sends out a real-time recall notification 82, 84 notifying the subscriber system 16 of the recalled medical device. The system 10 includes two types recall notifications, a yellow alert 82 and a red alert 84. In an alternative embodiment of this invention, the alert system may comprise a single tier system or a multiple-tiered system with or without three or more color codes. In the embodiment of FIG. 8, the yellow alert 82 alerts the subscriber system 16 of a recall that does not require immediate attention, for example, when the recalled medical device's identifier matches one of the identifiers 18, 20, 22 stored in the subscriber system 16 but the recalled medical device is not located in the subscriber system's inventory and the recalled medical device has not been used in a procedure. The red alert 84 alerts the subscriber system 16 of a recalled medical device that requires immediate attention. For example, when the recalled medical device's identifier matches one of the identifiers 18, 20, 22 for a device currently stored in the subscriber's inventory or previously used by the subscriber, the RTRIM system 10 will send the red alert 84. In a preferred embodiment, the alerts 82, 84 are displayed with a pop-up alert on a display in the subscriber system 16. The alerts 82, 84 may additionally or alternatively be transmitted to users 86, preferably authorized users, by electronic means, such as, but not limited to, an e-mail notification, a text message notification and an automated phone call. In an embodiment of this invention, the subscriber system 16 must acknowledge notification of the alert 82, 84 and/or indicate that appropriate response has been taken in response to the alert 82, 84.

In a preferred embodiment of this invention, recall notification details are included with the alert 82, 84 and the electronic notification. The recall notification details may include the supplier, the date of the recall and an appropriate action to take in response to the recall. The recall notification details may further include a report of the disposition of all the recalled devices in the subscriber's records. The recalled devices have at least four possible dispositions: used in patient care (e.g. implanted in patient); in current inventory; returned to supplier or manufacturer; or discarded or destroyed.

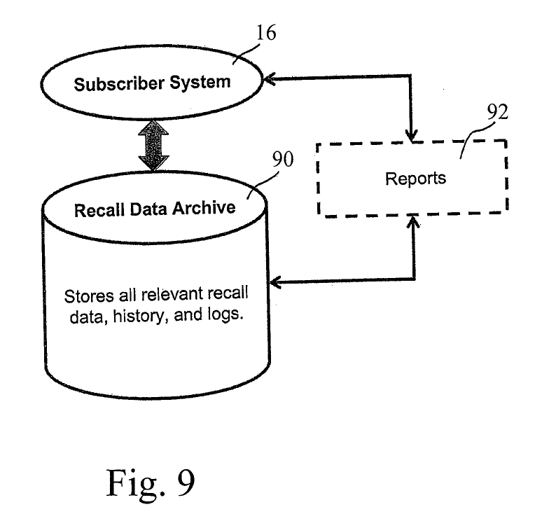

In a preferred embodiment of this invention, as shown in FIG. 9, the system 10 includes a subscriber recall data archive 90 for storing information relevant to each specific subscriber system (healthcare provider) from the recall notification system 10. Preferably, the data stored in the subscriber recall data archive 90 is limited to recall data relevant to devices that the subscriber system 16, has used in patient care, has in current inventory, returned to supplier and/or discarded. The subscriber recall data archive 90 may also store data of specific users who have viewed each recall and whether or not appropriate action has been taken in response to the recall. In a preferred embodiment, a report 92 can be generated from the subscriber recall data archive 90.

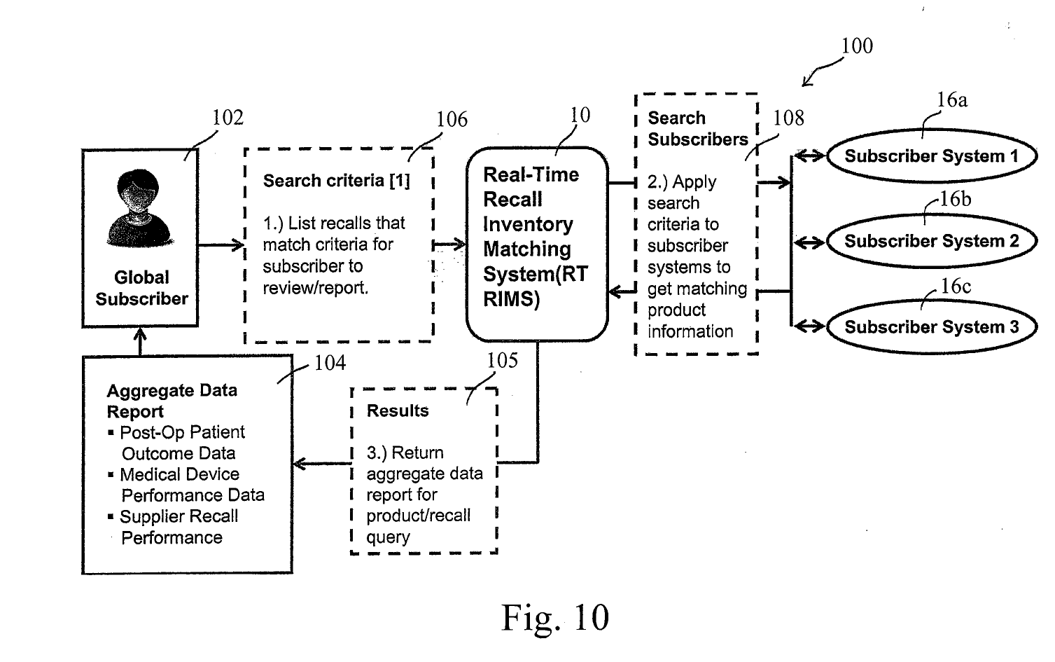

In an embodiment of this invention, the RTRIM system 10 further includes a process 100 for a global subscriber 102 to generate an aggregate data report 104 on a plurality of subscriber systems 16a, 16b, 16c to compile performance data including, but not limited to, post-operation outcome data, medical device performance data, and supplier recall performance. The global subscriber 102 may be any person or group that is interested compiling data on medical devices for studies and journal articles. The global subscriber 102 includes many types of people and groups including, but not limited to, university professors, journalists, lawyers, industry groups and healthcare providers. FIG. 10 is a preferred embodiment of the process 100 for generating aggregate data reports. The process 100 starts with the global subscriber 102 entering search criteria 106 into the RTRIM system 10 including product recalls, post-operation patient outcome, and a supplier's performance. The RTRIM system 10 applies the search criteria to a plurality of subscriber systems 16a, 16b, 16c to gather the desired product information 108. The RTRIM system 10 then returns an aggregate data report 105 to the global subscriber 102 with the results of the query.

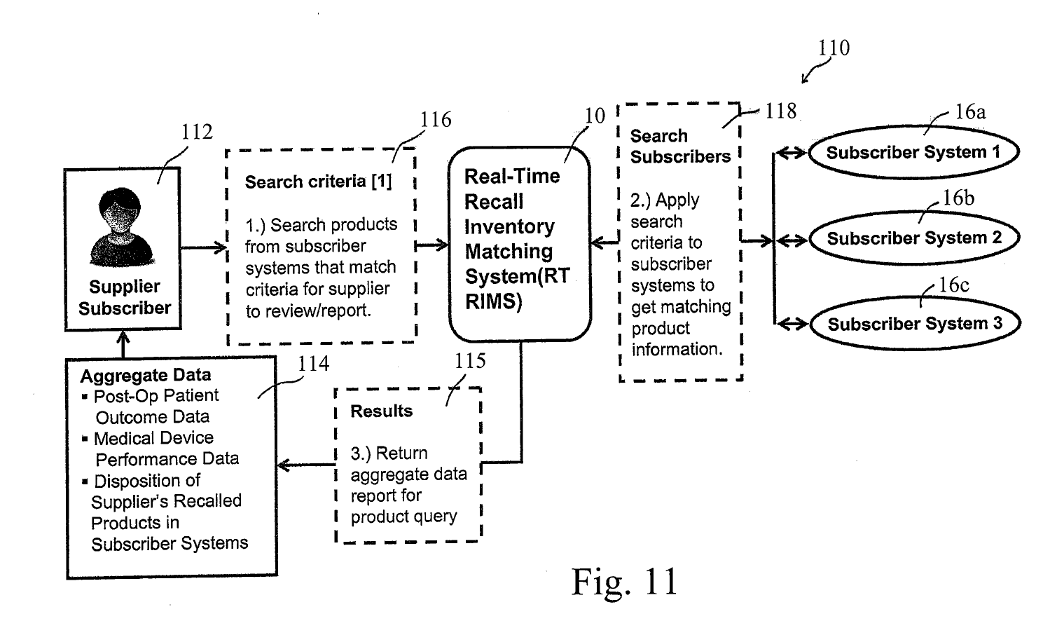

FIG. 11 shows a process 110 for a supplier subscriber 112 to generate an aggregate data report 114 of the supplier's product performance data including, but not limited to, post-operation patient outcome data, medical device performance data, and disposition of the supplier's recalled products in subscriber systems 16a, 16b, 16c. Unlike the global subscriber 102, the process 110 for the supplier subscriber 112 is preferably limited to data related to the supplier subscriber's 112 products. Alternatively, the process 110 may allow the supplier subscriber 112 to obtain reports of other subscribers for a product comparison or another reason. The process 110 starts with the supplier subscriber 112 entering search criteria 116 into the RTRIM system 10. The RTRIM system 10 applies the search criteria to a plurality of subscriber systems 16a, 16b, 16c to gather information on the supplier's products 118, such as performance statistics. The RTRIM system 10 then returns an aggregate report 115 to the supplier subscriber 112.

Thus, the invention provides an improved system and method for automatically matching medical device recall information to a healthcare provider's inventory and records to alert healthcare professionals of actions that should be taken in response to the recall.

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

What is claimed is:

1. A method for automatically managing recall information, the method comprising:
providing an inventory matching system, the inventory matching system comprising a database and a user interface;
populating the database with recall information;
associating a subscriber system with the inventory matching system, the subscriber system having a subscriber database including an identifier of a product; and
comparing the identifier of the product with the recall information to determine if the identifier of the product corresponds to the recall information.

2. The method of claim 1 further comprising:
alerting the subscriber system if the identifier of the product corresponds to the recall information.

3. The method of claim 2, wherein the alert comprises a tiered system of alerts including an immediate attention alert if the recall information corresponds to at least one of an identifier of a product in a subscriber inventory and a product implemented in a patient.

4. The method of claim 1, wherein the identifier of the product comprises at least one of a device identifier, a production identifier and a supplier identifier.

5. The method of claim 4, wherein the recall information includes at least one of a recall device identifier, a recall production identifier and a recall supplier identifier.

6. The method of claim 1, wherein the subscriber system includes identifiers of products currently in inventory.

7. The method of claim 1, wherein the subscriber system includes a record of identifiers of products used in patient care.

8. A method for automatically managing recall information of medical devices, the method comprising:
providing an inventory matching system, the inventory matching system comprising a database and a user interface;
populating the database with recall information of one or more medical devices;
associating a healthcare subscriber system with the inventory matching system, the healthcare subscriber system having a healthcare database, the healthcare database including identifiers of products in at least one of an inventory and implemented in patients;
comparing the identifiers of products with the recall information to determine if at least one of the identifier of the products corresponds to the recall information of one or more medical devices; and
alerting the health care subscriber system when at least one of the identifier of the products matches the recall information of one or more medical devices.

9. The method of claim 8, wherein the identifier of the products in the healthcare subscriber system each include at least one of a device identifier, a production identifier and a supplier identifier.

10. The method of claim 9, wherein the recall information of one or more medical devices includes at least one of a recall device identifier, a recall production identifier and a recall supplier identifier.

11. The method of claim 8 further comprising:
loading the recall information of one or more medical devices to the healthcare subscriber system.

12. The method of claim 8 further comprising:
creating a recall report of the recall information for the healthcare subscriber system.

13. The method of claim 8 further comprising:
entering a recalled medical device disposition for the healthcare subscriber system, the recalled medical device disposition comprising one of a device used in patient care, a device in current inventory, a device returned to one of a supplier and a manufacturer, and a device discarded.

14. The method of claim 8 further comprising:
entering a search criteria from the healthcare subscriber system into the inventory matching system;
applying the search criteria entered into the inventory matching system to one or more healthcare subscriber systems; and
providing an aggregate data report from the inventory matching system to the healthcare subscriber system.

15. The method of claim 14, wherein the aggregate data report includes at least one of a post-operation patient outcome data, a medical device performance data, and a supplier recall performance.

16. The method of claim 8 further comprising:
associating a global subscriber to the inventory matching system;
entering a search criteria from the global subscriber into the inventory matching system;
applying the search criteria entered into the inventory matching system to one or more healthcare subscriber systems; and
providing an aggregate data report from the inventory matching system to the global subscriber.

17. The method of claim 16, wherein the aggregate data report includes at least one of a post-operation patient outcome data, a medical device performance data, and a supplier recall performance.
